(19) United States
(12) Patent Application Publication
(10) Pub. No.: US 2013/0120995 A1
(43) Pub. Date: May 16, 2013

(54) SEMICONDUCTOR LIGHT-EMITTING ELEMENT MOUNTING MODULE AND SEMICONDUCTOR LIGHT-EMITTING ELEMENT MODULE

(71) Applicant: ATSUSHI SATO, KANAGAWA (JP)

(72) Inventor: ATSUSHI SATO, KANAGAWA (JP)

(21) Appl. No.: 13/673,239

(22) Filed: Nov. 9, 2012

(30) Foreign Application Priority Data
Nov. 10, 2011 (JP) 2011-246438
Jun. 18, 2012 (JP) 2012-136736

(51) Int. Cl. F21V 21/088

(52) U.S. Cl. CPC F21V 21/088
USPC 362/249.02; 362/396

(57) ABSTRACT

A semiconductor light-emitting element mounting module includes a metal conductor plate including anode and cathode terminal contacts on one side, wherein an anode and a cathode of a semiconductor light-emitting element is connectable to the anode and cathode terminal contacts, respectively; a metal thermal radiator member provided separate from the metal conductor plate; and a surface-insulation portion which covers the surfaces of the metal conductor plate and the thermal radiator member while exposing at least a part of the thermal radiator member and the anode and cathode terminal contacts. A clasping member is provided on the surface-insulation portion and projects from the one side of the metal conductor plate. The clasping member can come into contact with a light-receiving member, which receives light that is emitted from the semiconductor light-emitting element.

### CROSS REFERENCE TO RELATED APPLICATIONS

The present invention is related to and claims priority of the following co-pending application, namely, Japanese Patent Application No. 2011-246438 filed on Nov. 10, 2011, and Japanese Patent Application No. 2012-136736 filed on Jun. 18, 2012 and hereby incorporated by reference in its entirety.

### BACKGROUND OF THE INVENTION

1. Field of the Invention

The present invention relates to a semiconductor light-emitting element mounting module to which semiconductor light-emitting elements (LEDs) can be mounted, and relates to a semiconductor light-emitting element module.

2. Description of Related Art

In recent years, light fixtures which utilize LEDs (semiconductor light-emitting elements) have been used in various fields, such as for an interior light fixture or a backlight for use in an LCD monitor, etc.

A light fixture which utilizes LEDs is typically configured by arranging a large number of circuit boards (rigid substrates), onto which one or a plurality of LEDs are installed on one side, in a chain-like manner (either linear or planar), and connecting adjacent circuit boards with an electrical connector.

Examples of the related art are disclosed in Japanese Patent Domestic Announcement Nos. 2010-525523 and 2010-505232, and Japanese Patent Publication Nos. 2010-62556 and 2010-98302.

However, since the radiativity of the circuit boards (rigid substrates) that are utilized in the above-mentioned related art is far from being favorable, the light fixtures of the above-mentioned related art cannot efficiently radiate the heat that is generated by the LEDs.

Furthermore, an electrical conductive section (e.g., a circuit pattern) is exposed on the surface of the circuit board. Accordingly, if a metal thermal radiator plate for absorbing heat generated by the light fixture is provided close to the light fixture or provided on an inner side of a metal body for storing the light fixture, there is a risk of short-circuiting occurring between the radiator plate or metal body and the light fixture.

Hence, since a radiator plate cannot be installed close to the light fixture, a sufficient heat-radiating effect cannot be achieved in the case where a radiator plate is utilized.

Furthermore, in the case where the light fixture is mounted onto a side surface of an LCD panel unit (which is a laminate of an LCD panel, a light guide plate and a reflection plate), and light is made incident on the side surface of the light guide plate, it was not easy to precisely mount the light fixture onto the side surface of the LCD panel. If the mounting precision deteriorates, light is not sufficiently made incident onto the light guide plate, causing deterioration of luminance and causing luminance irregularities.

### SUMMARY OF THE INVENTION

The present invention provides a semiconductor light-emitting element mounting module and a semiconductor light-emitting element module which exhibit favorable radiativity, have a greatly-reduced risk of short-circuiting even in the case where electrically conductive members (for example thermal radiator plates) are arranged close to a thermal radiator plate, have a high-precision mounting capability and can be mounted in a simple manner onto a side of an LCD panel unit.

According to an aspect of the present invention, a semiconductor light-emitting element mounting module is provided, including a metal conductor plate including an anode terminal contact and a cathode terminal contact formed on one side thereof, wherein an anode and a cathode of a semiconductor light-emitting element is connectable to the anode terminal contact and the cathode terminal contact, respectively; a metal thermal radiator member which is provided separate from the metal conductor plate; and a surface-insulation portion which covers the surfaces of the metal conductor plate and the thermal radiator member while exposing at least a part of the thermal radiator member, exposing the anode terminal contact and the cathode terminal contact. A clasping member is provided on a part of the surface-insulation portion which covers the one side of the metal conductor plate, the clasping member projecting from the part of the surface-insulation portion and in an opposite direction with respect to the one side of the metal conductor plate, and wherein the clasping member can come into contact with a light-receiving member, which receives light that is emitted from the semiconductor light-emitting element.

It is desirable for a pair of the clasping members, into which the light-receiving member can be positioned therebetween, to be provided on the part of the surface-insulation portion which covers the one side of the metal conductor plate, wherein the pair of clasping members interposes the anode terminal contact and the cathode terminal contact so that the pair of clasping members face each other.

Accordingly, since a light receiving member (such as, for example, a side edge of an LCD panel unit) can be fitted in between a pair of clasping members that are provided on the surface-insulation portion, the semiconductor light-emitting element mounting module can be precisely and easily mounted onto the light receiving member.

It is desirable for a contact protrusion, to which an end surface of the light-receiving member is contactable, to be formed on the part of the surface-insulation portion which covers the one side of the metal conductor plate, wherein the contact protrusion is positioned between the pair of clasping members and projects from the part of the surface-insulation portion and in the opposite direction with respect to the one side of the metal conductor plate by a projecting amount smaller than that of the pair of clasping members.

Accordingly, since a space (gap) is formed between the LED that is mounted to the anode terminal contact and the cathode terminal contact of the conductor plate and the edge surface of the light receiving member, heat from the LED can be efficiently radiated. Therefore, the possibility of heat from the LED adversely affecting the light receiving member is reduced.

It is desirable for the surface-insulation portion to expose part of the thermal radiator member at the one side and expose a part that is different from the part of the thermal radiator member on a side that is different from the one side.

Accordingly, a more superior heat radiating effect can be achieved.

It is desirable for the semiconductor light-emitting element mounting module to include a pair of connector terminal contacts which are electrically conductive with the anode terminal contact and the cathode terminal contact, respectively. The surface-insulation portion exposes the pair of connector terminal contacts, and the pair of connector terminal contacts are connectable to the pair of connector terminal contacts of another the semiconductor light-emitting element mounting module.

In such an arrangement, the metal conductor plate and the connector terminal contacts can be provided as separate members.

Accordingly, it is possible to connect a plurality of semiconductor light-emitting element mounting modules.

Furthermore, since freedom in design of the terminal contacts is improved, a desired terminal contact shape can be formed.

It is desirable for the metal conductor plate to include a linearly extending member, and for one pair of connector terminal contacts to be provided at each end of the metal conductor plate, with respect to the elongated direction of the metal conductor plate.

Accordingly, by connecting the semiconductor light-emitting element mounting modules in a chain-like manner, a desired length of semiconductor light-emitting element mounting modules can be obtained.

It is desirable for the anode terminal contact and the cathode terminal contact to constitute a pair of terminal contacts, and for the metal conductor plate to include a plurality of the pairs of terminal contacts.

Accordingly, a plurality of semiconductor light-emitting elements can be mounted onto one semiconductor light-emitting element mounting module.

In an embodiment, a semiconductor light-emitting element module is provided, including the above-described semiconductor light-emitting element mounting module; a plurality of the semiconductor light-emitting elements, wherein an anode and a cathode of each of the semiconductor light-emitting elements are respectively connected to the anode terminal contact and the cathode terminal contact of each corresponding pair of terminal contacts, and wire bonding which is applied onto the anode of each semiconductor light-emitting element and each anode terminal contact, and onto the cathode of each semiconductor light-emitting element and each cathode terminal contact.

Accordingly, since the anode terminal contacts and the cathode terminal contacts are connected to the anode and cathode of the semiconductor light-emitting element via wire bonding, the distance between each semiconductor light-emitting element can be narrowed (reduced) compared to the case in which soldering is used to connect each semiconductor light-emitting element to the anode terminal contact and the cathode terminal contact. Therefore, luminance irregularities in the semiconductor light-emitting element module can be reduced and the luminance thereof can be improved.

Furthermore, since it is unnecessary to carry out reflow, like in the case of using solder, when the semiconductor light-emitting element is connected (installed) to the anode terminal contact and the cathode terminal contact, there is little possibility of the semiconductor light-emitting element module being adversely influenced (warpage or discoloring of the resin) by heat.

It is desirable for the semiconductor light-emitting element module to include a transparent resin sealant which covers the surfaces of the semiconductor light-emitting elements and the wire bonding.

Accordingly, the semiconductor light-emitting element and the wire bonding can be protected by the sealant.

### EFFECTS OF THE INVENTION

According to the present invention, since a structure is employed in which the thermal radiator member, having superior thermal conductivity and rigidity, is provided close to the semiconductor light-emitting element (LED) while being exposed from an external surface of the semiconductor light-emitting element mounting module, heat generated by the LEDs is efficiently radiated externally through the conductive member. Furthermore, since the thermal radiator plate can be provided closer to the semiconductor light-emitting element mounting module (semiconductor light-emitting element module), i.e., short-circuiting does not occur, a more effective thermal radiating effect can be obtained by utilizing the radiator plate.

Furthermore, since the resin surface-insulation portion covers the entire surface of the conductor plate except for the anode and cathode terminal contacts, heat from the LEDs is efficiently received and dispersed by the conductor plate, and heat is efficiently externally radiated through the conductor plate and the thin surface-insulation portion.

In other words, a synergistic thermal radiation effect of direct thermal radiation via the thermal radiator member and indirect thermal radiation via the conductor plate and the surface-insulation portions can be obtained. Therefore, heat does not easily get trapped in the semiconductor light-emitting element mounting module, so that deterioration of the light-emitting efficiency of the LED can be suppressed.

Furthermore, since the entire surface of the conductor plate, except for the

anode and cathode terminal contacts, is covered by the surface-insulation portion, and since the thermal radiation member, a part of which is externally exposed, is separated (by a gap) from the conductor plate (i.e., is insulated by the surface-insulation portion), even if the thermal radiator plate or an inner surface of a metal body for housing the semiconductor light-emitting element mounting module (semiconductor light-emitting element module) is provided on the surface opposite to the surface on which the anode and cathode terminal contacts are provided, of the semiconductor light-emitting element mounting module, short-circuiting between the semiconductor light-emitting element mounting module and the thermal radiator plate or the metal body does not occur.

Furthermore, since a side edge portion of the LCD panel unit, as an example of a light-receiving member, can be mounted to a clasping member that is formed on the surface-insulation portion (a pair of clasping members can be provided on the surface-insulation portion and a side edge of the LCD panel unit can be fitted between the pair of clasping members, or one clasping member can be provided on the surface-insulation portion and a side edge of the LCD panel unit can be fitted between the clasping member and another member), the semiconductor light-emitting element mounting module can be easily and precisely mounted onto the side of the LCD panel unit. Accordingly, it is possible to suppress deterioration in luminance and luminance irregularities in the LCD panel.

### BRIEF DESCRIPTION OF THE DRAWINGS

The present invention will be discussed below in detail with reference to the accompanying drawings, in which:

FIG. 1 is a plan view of a conductor plate according to a first embodiment of the present invention;

FIG. 2 is a side elevation of the conductor plate;

FIG. 3 is a perspective view of the conductor plate, as viewed in an oblique direction from the front upper side thereof;

FIG. 4 is an enlarged perspective view of an anode terminal contact, a cathode terminal contact, and the peripheral portion thereof, of the conductor plate, as viewed in an oblique direction from the front upper side thereof;

FIG. 5 is an enlarged perspective view of a front end portion of the conductor plate and front connector terminal contacts, as viewed in an oblique direction from the front upper side thereof;

FIG. 6 is an enlarged perspective view of a rear end portion of the conductor plate and rear connector terminal contacts, as viewed in an oblique direction from the front upper side thereof;

FIG. 7 is a plan view showing an integrated component of the conductor plate, the front connector terminal contacts and the rear connector terminal contacts, with the surfaces thereof covered with a first surface-insulation portion;

FIG. 8 is an underside plan view showing the integrated component of the conductor plate, the front connector terminal contacts and the rear connector terminal contacts, with the surfaces thereof covered with the first surface-insulation portion;

FIG. 9 is an enlarged perspective view of a front end of the integrated component of the conductor plate, the front connector terminal contacts and the rear connector terminal contacts, with the surfaces thereof covered with the first surface-insulation portion, as viewed in an oblique direction from the front upper side thereof;

FIG. 10 is an enlarged perspective view of a rear end of the integrated component of the conductor plate, the front connector terminal contacts and the rear connector terminal contacts, with the surfaces thereof covered with the first surface-insulation portion, as viewed in an oblique direction from the front upper side thereof;

FIG. 11 is a perspective view of the integrated component of the conductor, the front connector terminal contacts, the rear connector terminal contacts and the first surface-insulation portion upon a first cutting process being performed thereon, as viewed in an oblique direction from the front upper side thereof;

FIG. 12 is a plan view showing the integrated component of the conductor, the front connector terminal contacts, the rear connector terminal contacts and the first surface-insulation portion upon a first cutting process being performed thereon;

FIG. 13 is an enlarged sectional view taken along the XIII-XIII line shown in FIG. 12, viewed in the direction of the appended arrows;

FIG. 14 is an enlarged sectional view taken along the XIV-XIV line shown in FIG. 12, viewed in the direction of the appended arrows;

FIG. 15 is an exploded perspective view of the integrated component of the conductor, the front connector terminal contacts, the rear connector terminal contacts and the first surface-insulation portion, and a thermal radiator member, as viewed in an oblique direction from the front upper side thereof;

FIG. 16 is an exploded perspective view of the integrated component of the conductor, the front connector terminal contacts, the rear connector terminal contacts and the first surface-insulation portion, and a thermal radiator member, as viewed in an oblique direction from the rear lower side thereof;

FIG. 17 is a perspective view of the thermal radiator member installed onto the integrated component of the conductor, the front connector terminal contacts, the rear connector terminal contacts and the first surface-insulation portion, as viewed in an oblique direction from the front upper side thereof;

FIG. 18 is an enlarged sectional view, similar to that of FIG. 13, of an integrated component of the conductor, the front connector terminal contacts, the rear connector terminal contacts, the first surface-insulation portion and the thermal radiator member;

FIG. 19 is an enlarged sectional view, similar to that of FIG. 14, of an integrated component of the conductor, the front connector terminal contacts, the rear connector terminal contacts, the first surface-insulation portion and the thermal radiator member;

FIG. 20 is a plan view of an LED mounting module that has been completed upon a second surface-insulation portion being formed onto the surface of the first surface-insulation portion;

FIG. 21 is an underside plan view of the LED mounting module;

FIG. 22 is a perspective view of the LED mounting module, as viewed in an oblique direction from the front upper side thereof;

FIG. 23 is an enlarged sectional view taken along the XXIII-XXIII line shown in FIG. 20, viewed in the direction of the appended arrows;

FIG. 24 is an enlarged sectional view taken along the XXIV-XXIV line shown in FIG. 20, viewed in the direction of the appended arrows;

FIG. 25 is an enlarged sectional view taken along the XXV-XXV line shown in FIG. 20, viewed in the direction of the appended arrows;

FIG. 26 is an enlarged sectional view, similar to FIGS. 24 and 25, showing a state when adjacent connector terminal contacts of two LED modules are connected to each other;

FIG. 27 is a perspective view of the LED mounting module when LED elements are placed onto each corresponding anode terminal contact and cathode terminal contact, as viewed in an oblique direction from the front upper side thereof;

FIG. 28 is an enlarged sectional view, similar to that of FIG. 23, of the LED mounting module when LED elements are placed onto each corresponding anode terminal contact and cathode terminal contact;

FIG. 29 is an enlarged sectional view, similar to that of FIG. 14, of the LED mounting module when LED elements are placed onto each corresponding anode terminal contact and cathode terminal contact;

FIG. 30 is an exploded perspective view of an LED module and an LCD panel unit, as viewed in an oblique direction from the front upper side thereof;

FIG. 31 is a perspective view of a side edge of the LCD panel unit fitted into the LED module, as viewed in an oblique direction from the front upper side thereof;

FIG. 32 is an elevation side view of the side edge of the LCD panel unit fitted into the LED module;

FIG. 33 is an enlarged sectional view taken along the XXXIII-XXXIII line shown in FIG. 32, viewed in the direction of the appended arrows;

FIG. 34 is a schematic diagram of the conductor plates and the series circuit therefor;

FIG. 35 is an exploded perspective view, similar to that of FIG. 30, of a modified embodiment of the LED module and the LCD panel unit;

FIG. 36 an enlarged sectional view, similar to that of FIG. 33, of a modified embodiment of the LED module and the LCD panel unit;

FIG. 37 is an enlarged sectional view of another modified embodiment of the LED module and the LCD panel unit, taken along a line that corresponds to the XXXVII-XXXVII line of FIG. 29; and

FIG. 38 is an enlarged sectional view, corresponding to that of FIG. 37, of yet another modified embodiment of the LED module and the LCD panel unit.

### DESCRIPTION OF THE EMBODIMENTS

An embodiment of the present invention will be hereinafter discussed with reference to the accompanying drawings. Note that in the explanations hereinbelow, the “upward”, “downward”, “left”, “right”, “forward” and “rearward” directions are based on the directions of the arrows that are indicated in the drawings.

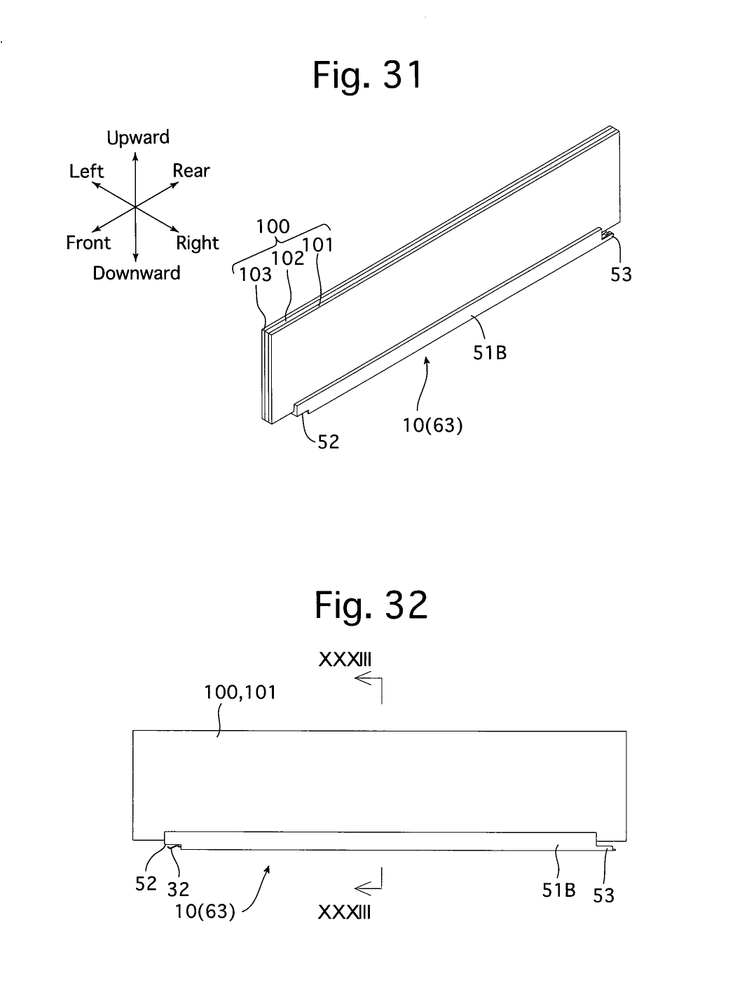

In the illustrated embodiment, the present invention is applied to an LED module (semiconductor light-emitting element module) 10. The LED module 10 can be used as, e.g., a light source for an LCD panel unit (light receiving member) 100 (see FIGS. 30 through 33). The LCD panel unit 100 of the illustrated embodiment is a so-called “edge-lighting” type in which light is incident onto a side surface of a light guide plate 102.

The LED module 10 is configured of at least one LED element (semiconductor light-emitting element) 57 mounted onto an LED mounting module (semiconductor light-emitting element mounting module) 15, wire bonding 61, and a sealant 62. The LED mounting module 15 is provided with a conductor plate 17, a front connector terminal contact 30, a rear connector terminal contact 33, a first surface-insulation portion 37, a thermal radiator member 45, and a second surface-insulation portion 50.

First, the detailed structure and the production method of the LED mounting module 15 will be described hereinbelow.

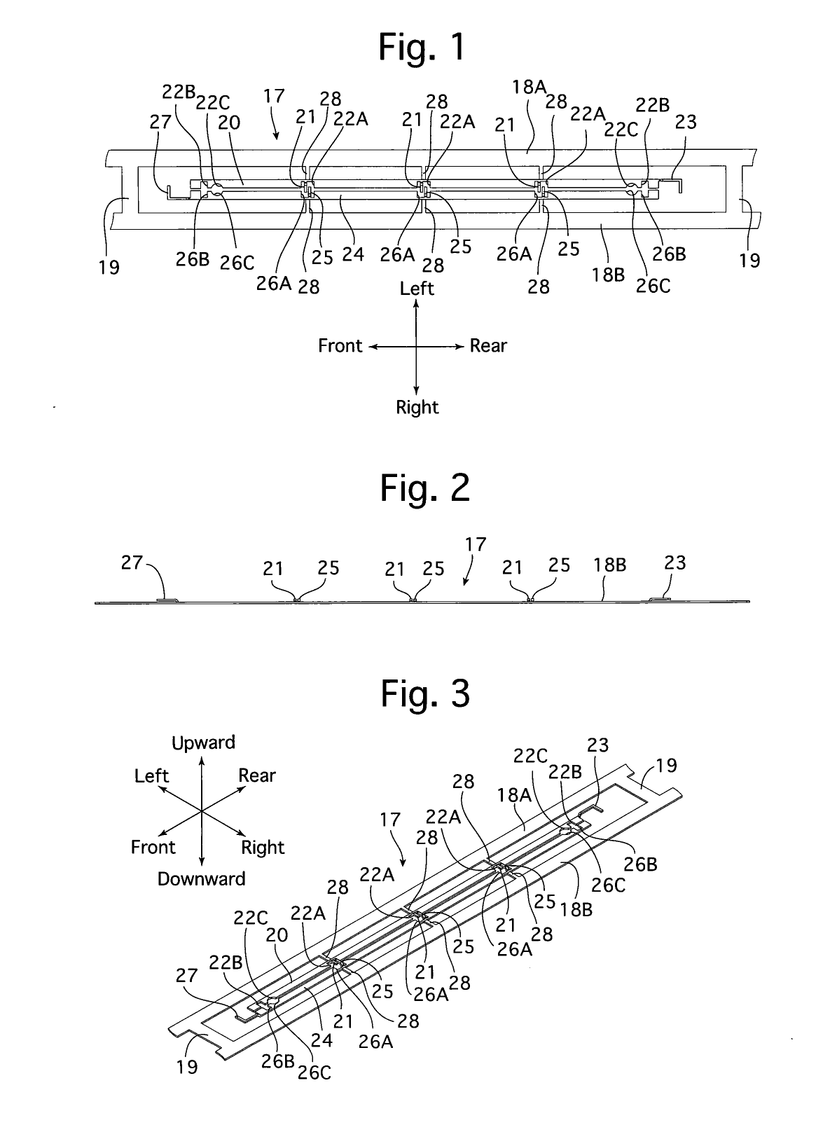

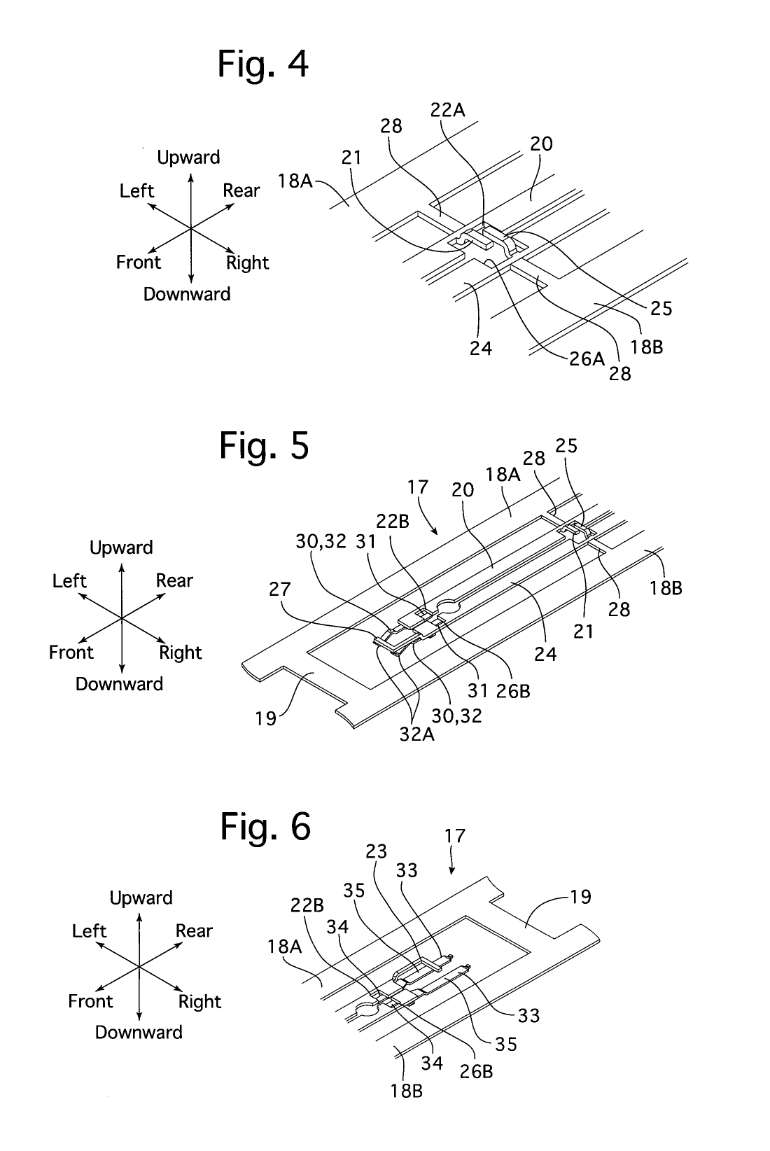

FIGS. 1 through 4 show the conductor plate 17 which constitutes a base material for the LED mounting module 15. The conductor plate 17 is made from a flat metal plate such as brass, beryllium copper or Corson copper alloy, etc., having superior electrical conductivity, thermal conductivity, rigidity, and also having elasticity (flexibility), and is formed by a stamping process. Furthermore, since the surface of the conductor plate 17 has been silver plated, a favorable reflectivity (of light) of the surface of the conductor plate 17 is achieved. The overall shape of the conductor plate 17 is elongated to extend in the forward/rearward direction (e.g., the length in the forward/rearward direction can be approximately 15 cm), and is shaped as a flat plate except for an anode terminal contact 21, an anode terminal contact projection 23, a cathode terminal contact 25 and a cathode terminal contact projection 27 (which will be discussed hereinbelow). Each of the left and right sides of the conductor plate 17 are provided with forwardly/rearwardly extending carrier sections 18A and 18B, respectively. The conductor plate 17 is also provided with carrier-connector sections 19 which connect a plurality of adjacent portions of the carrier sections 18A and 18B to each other at equal intervals in the forward/rearward direction. A first circuit-forming section 20 and a second circuit-forming section 24 are formed in a section of the conductor plate 17 that is surrounded by the carrier sections 18A and 18B and two adjacent carrier-connector sections 19 so that the first and second circuit-forming sections 20 and 24 are arranged mutually separate from each other in the left/right direction while extending in the forward/rearward direction (a plurality of pairs of the first circuit-forming sections 20 and the second circuit-forming sections 24 are formed in one conductor plate 17). A plurality of communicative recesses 22A are formed on the first circuit-forming section 20, and an anode terminal contact 21 which is positioned a step higher than the first circuit-forming section 20 is integrally formed on the edge of each communicative recess 22A and projects therefrom. In addition, a temporary holding recess 22B and a communicative recess 22C are formed close to each of the front and rear ends of the first circuit-forming section 20. Furthermore, an anode terminal projection 23, having an L-shape in a plan view and positioned a step higher than the first circuit-forming section 20, is integrally formed on the rear end of the first circuit-forming section 20. A communicative recess 26A is formed on the second circuit-forming section 24 at a position that corresponds to each anode terminal contact 21. A cathode terminal contact 25 positioned a step higher than the second circuit-forming section 24 is integrally formed onto the end of the communicative recess 26A and projects therefrom. In addition, a temporary holding recess 26B and a communicative recess 26C are formed close to each of the front and rear ends of the second circuit-forming section 24. Furthermore, a cathode terminal projection 27, having an L-shape in a plan view and positioned a step higher than the second circuit-forming section 24, is integrally formed on the front end of the second circuit-forming section 24. The carrier section 18A and the first circuit-forming section 20 are connected to each other via a plurality of left/right extending cutoff bridges 28, and the carrier section 18B and the second circuit-forming section 24 are connected to each other via a plurality of left/right extending cutoff bridges 28. Furthermore, the outer edge portions of the carrier sections 18A and 18B are provided with a large number of round conveyor holes or half-holes (recesses) arranged in the front/rear direction thereof (not shown).

A pair of front connector terminal contacts (contact parts) 30 are attached to the front end of the conductor plate 17 and a pair of rear connector terminal contacts (contact parts) 33 are attached to the rear end of the conductor plate 17.

The pair of left and right front connector terminal contacts 30 have been formed into the shape shown in FIGS. 5, 24 and 26, etc., by stamping a metal flat plate, e.g., phosphor bronze (or other metal) having superior conductive properties and elasticity, and the surfaces of the front connector terminal contacts 30 have been plated with gold or tin, etc. The left and right front connector terminal contacts 30 are each provided with a crimped portion 31 at the rear end portion thereof, and a contact part 32 which extends forwardly from the crimped portion 31. A contact protrusion 32A is formed on each contact part 32. As shown in FIG. 5, the left and right front connector terminal contacts 30 are temporarily joined to the conductor plate 17 by the crimped portions 31 crimping the temporary holding recesses 22B and 26B.

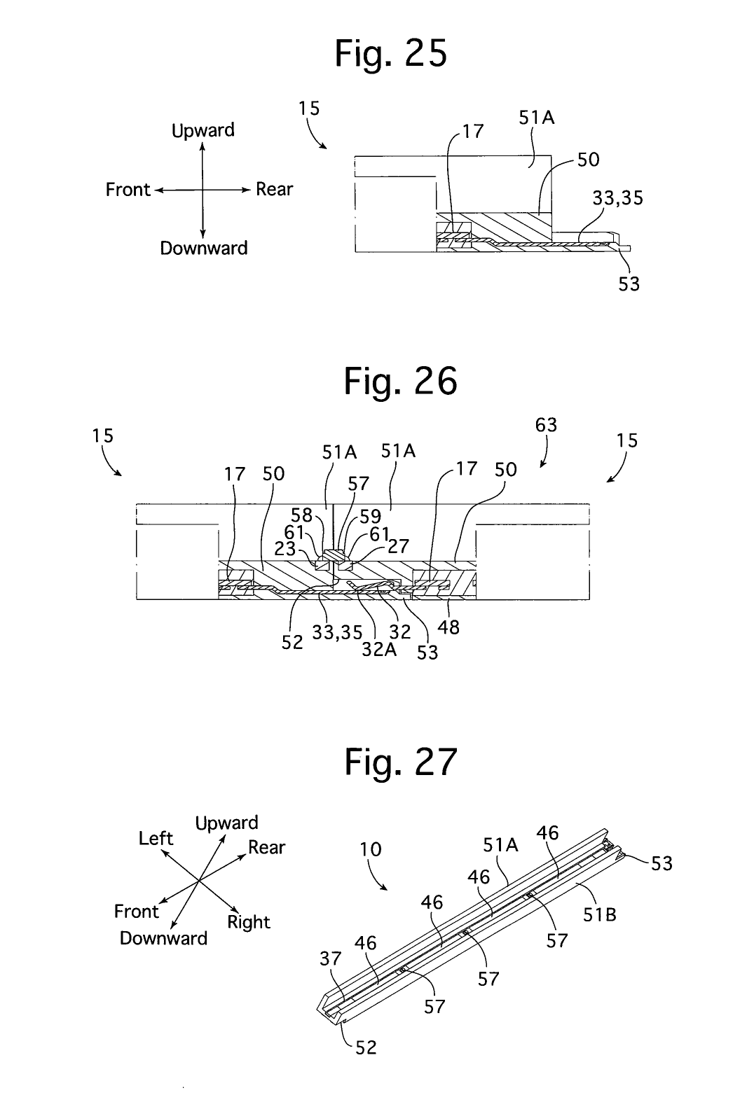

Similarly, the pair of left and right rear connector terminal contacts 33 have also been formed into the shape shown in FIGS. 6, 25 and 26, etc., by stamping a metal flat plate, e.g., phosphor bronze (or other metal) having superior conductive properties and elasticity, and the surfaces of the rear connector terminal contacts 33 have been plated with gold or tin, etc. The left and right rear connector terminal contacts 33 are each provided with a crimped portion 34 at the front end portion thereof, and a contact part 35 which extends rearwardly from the crimped portion 34 and is positioned a step downward from the crimped portion 34. As shown in FIG. 6, the left and right rear connector terminal contacts 33 are temporarily joined to the conductor plate 17 by the crimped portions 34 crimping the temporary holding recesses 22B and 26B.

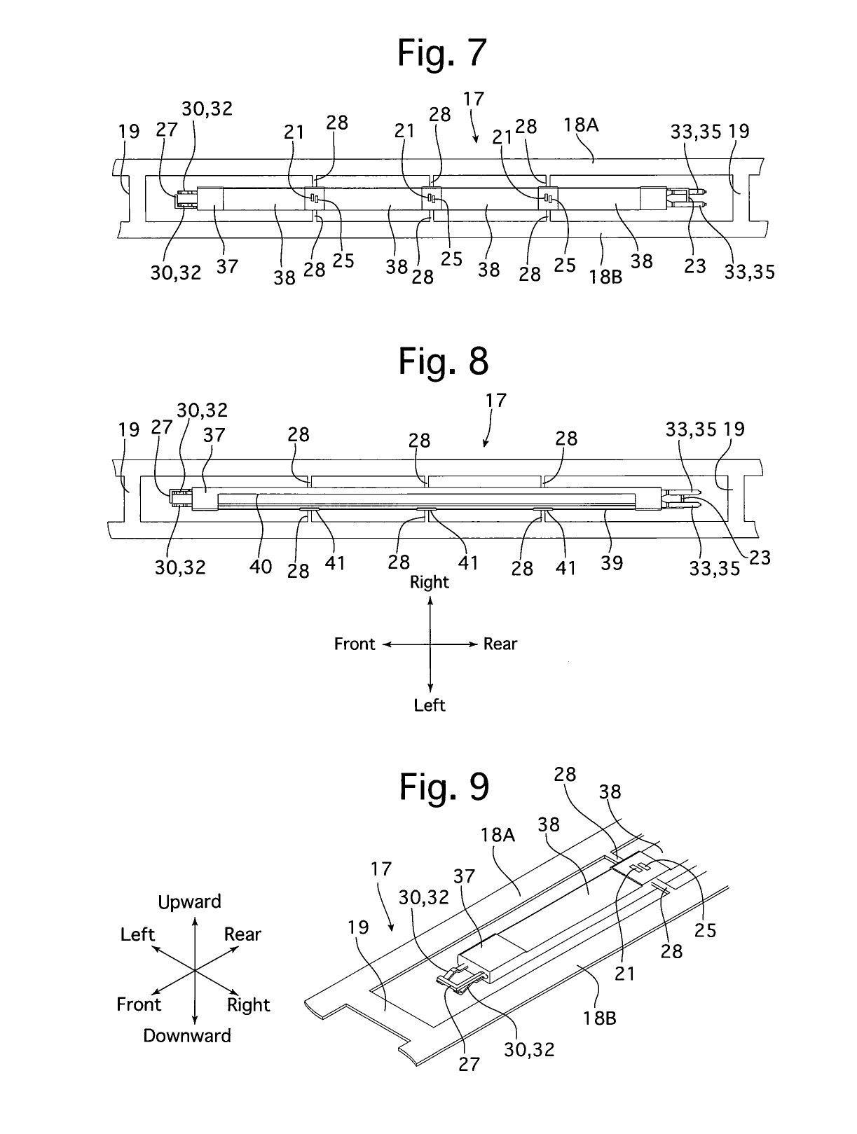

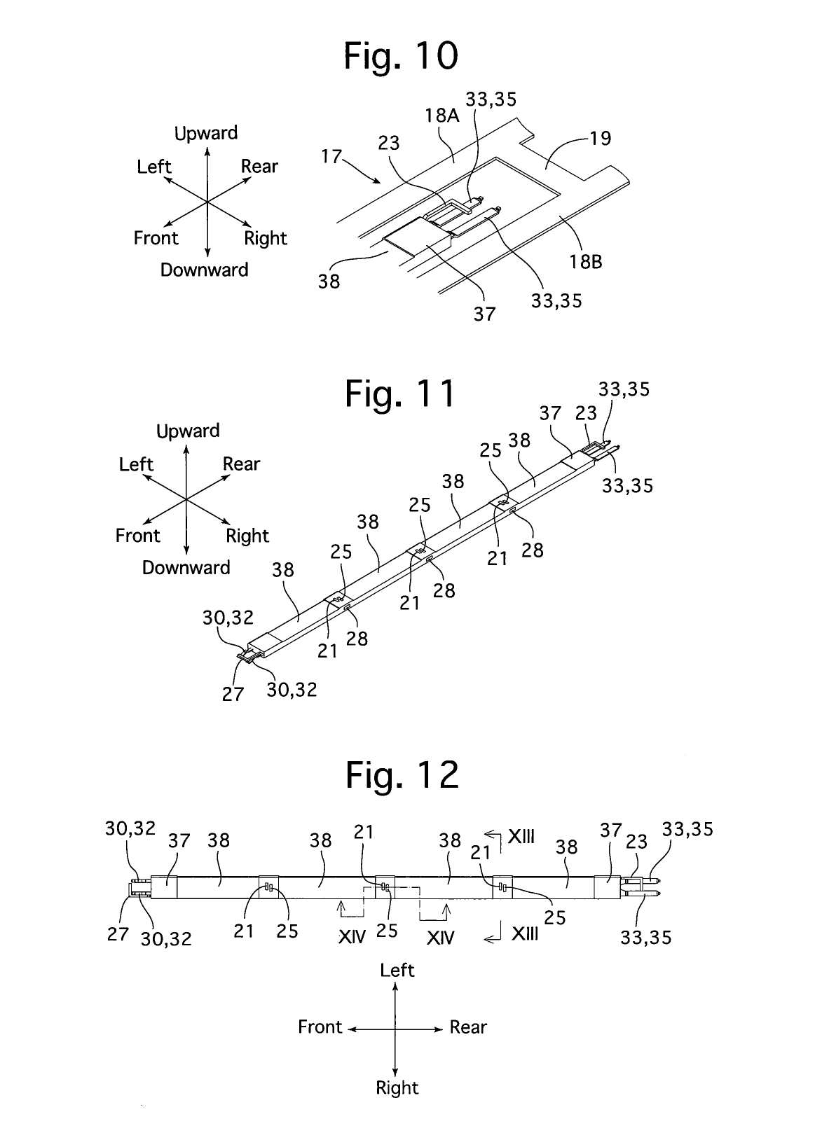

The conductor plate 17 having the above-described structure (in which the front connector terminal contacts 30 and the rear connector terminal contacts 33 are integrated with the conductor plate 17 to constitute an integrated component) is engaged onto sprockets of a conveyer apparatus (not shown) via the conveyor holes of the conductor plate 17 so that the integrated component (of the conductor plate 17, and the front and rear connector terminal contacts 30 and 33) is conveyed in the rearward direction via rotation of the sprockets. Thereafter, upon integrated component being conveyed to a predetermined position, a pair of primary molding dies (not shown) made of metal that are positioned above and below the integrated component close over the conductor plate 17 so that the conductor plate 17 is accommodated inside the primary molding dies. Thereupon, a large number of support pins (not shown) that are provided in the primary molding dies are fitted into the respective conveyor holes (not shown) of the conductor plate 17, from which the sprockets have been removed, to thereby fix the integrated component inside the primary molding dies. Thereafter, injection molding (primary molding) using a resin material (e.g., a liquid crystal polymer, etc.) having superior insulation properties, high reflectivity (of light) and high heat resistance is carried out in the primary molding dies. Subsequently, upon the resin material curing, each die of the primary molding dies is separated, upwardly and downwardly, from the integrated component to thereby remove the integrated component from the primary molding dies, thereby producing an integrated component in which the first surface-insulation portion 37 is integrally formed on the surface of the conductor plate 17, the front connector terminal contacts 30 and the rear connector terminal contacts 33 (see FIGS. 7 through 10).

As shown in the drawings, the first surface-insulation portion 37 integrally covers the surfaces of the conductor plate 17, the front connector terminal contacts 30 and the rear connector terminal contacts 33, with the anode terminal contacts 21, the anode terminal projections 23, the cathode terminal contacts 25, the cathode terminal projections 27, the contact parts 32 (portions thereof) and the contact parts 35 (portions thereof) remaining exposed. On the upper surface of the first surface-insulation portion 37, a plurality of upper-surface recesses 38 are formed between adjacent communicative recesses 22A (communicative recesses 26A), between the front end communicative recess 22A (communicative recess 26A) and the cathode terminal projection 27, and between the rear end communicative recess 22A (communicative recess 26A) and the anode terminal projection 23. On the left side surface of the first surface-insulation portion 37, side recesses 39 are formed continuously with the left edges of the upper-surface recesses 38. On the underside of the first surface-insulation portion 37, underside recesses 40 are formed continuously with the lower edges of the side recesses 39. Furthermore, a plurality of engaging projections 41 are provided on the left side of the first surface-insulation portion 37. The portion of the first surface-insulation portion 37 positioned on the upper side of the conductor plate 17 and the portion of the first surface-insulation portion 37 positioned on the lower side of the conductor plate 17 are mutually integral via the resin material that has cured inside the communicative recesses 22A, the temporary holding recesses 22B and 26B, and the communicative recesses 22C and 26C.

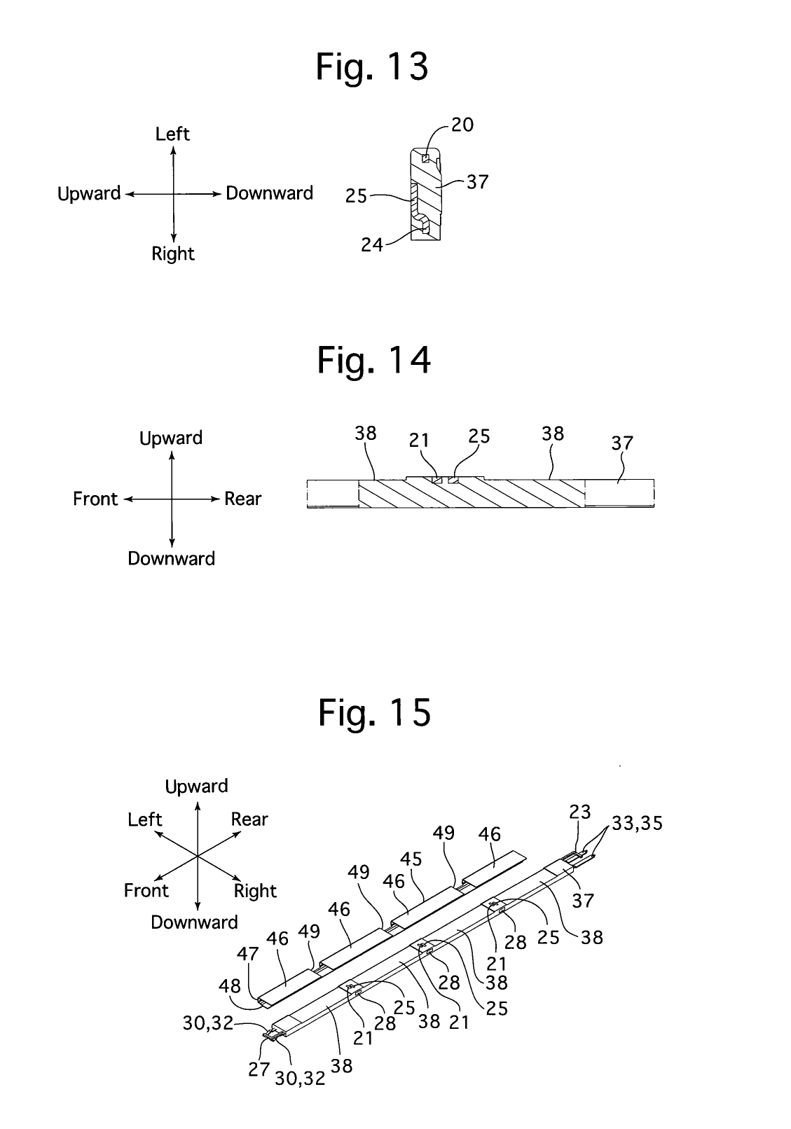

Subsequently, each of the carrier-connector sections 19 and the cutoff bridges 28 of the integrated component consisting of the conductor plate 17, the front connector terminal contacts 30, the rear connector terminal contacts 33, and the first surface-insulation portion 37 are linearly cut in a forward / rearward direction along the left and right side surfaces of the first surface-insulation portion 37 in a primary cutting operation (see FIGS. 11 through 14) using a primary cutting apparatus (not shown).

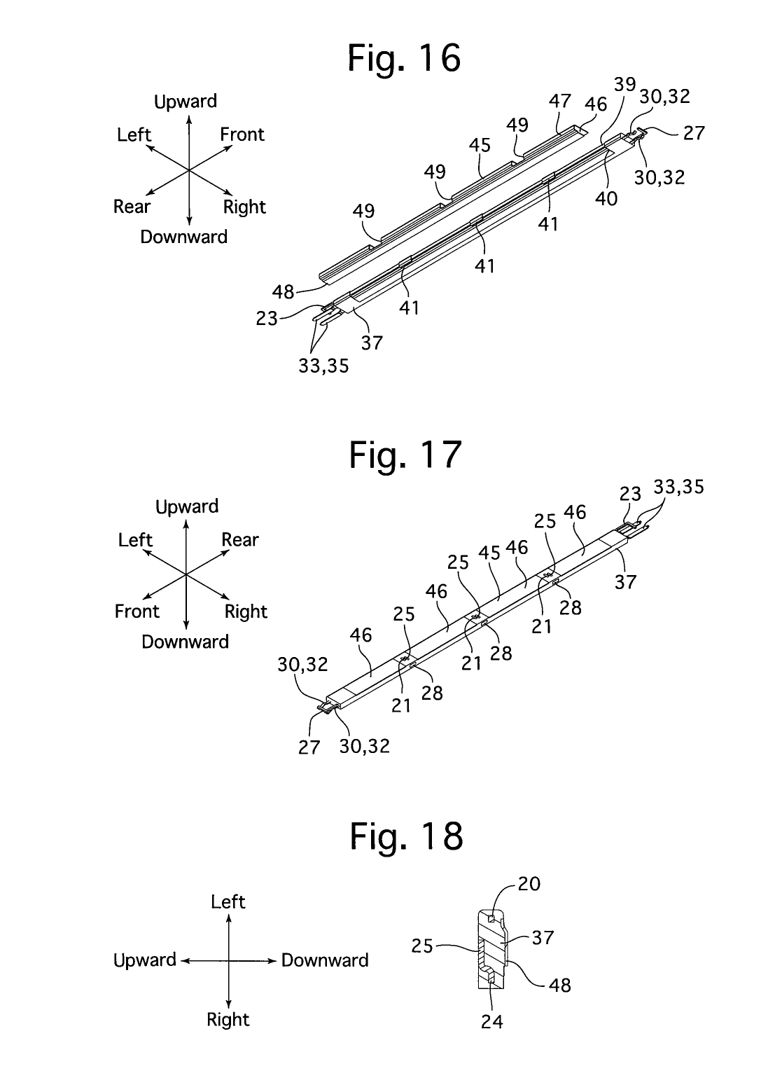

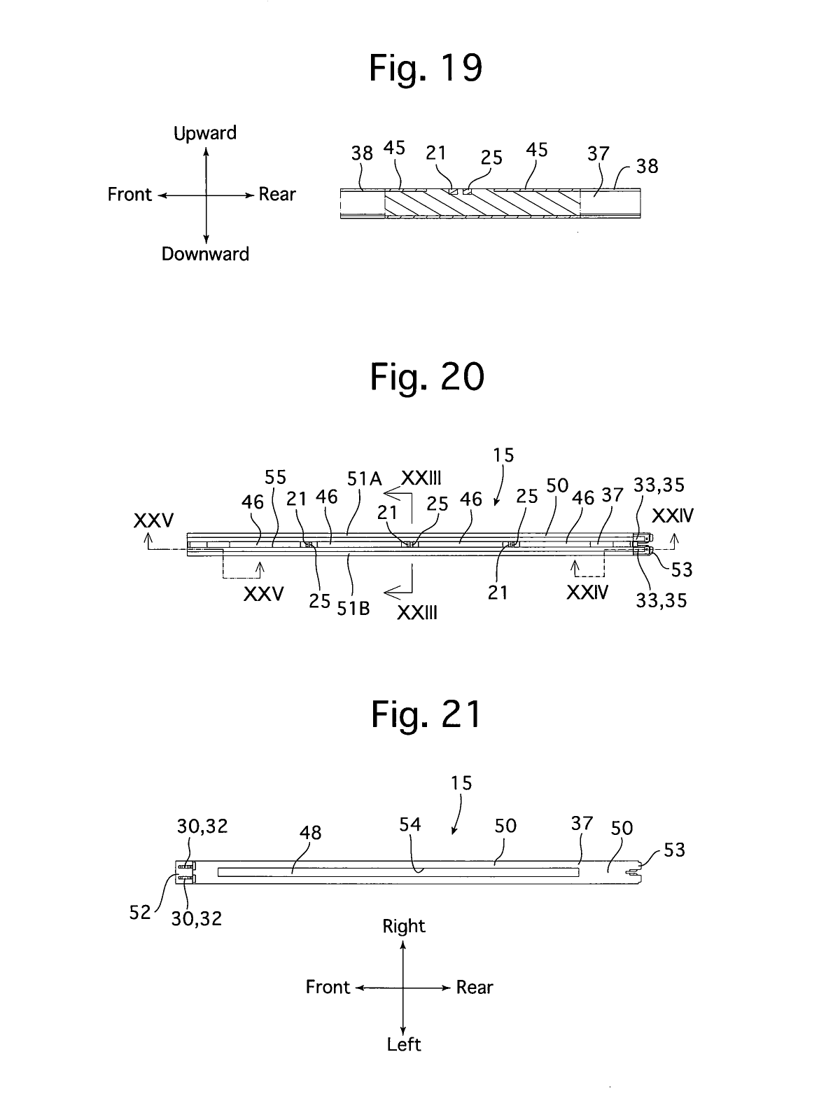

Upon completion of the primary cutting operation, a metal thermal radiator member 45 is placed over the upper-surface recesses 38, the side recesses 39, and the underside recesses 40 of the first surface-insulation portion 37. The thermal radiator member 45 is a pressed product formed from a metal plate and is integrally provided with a plurality of (corresponding to the same number of upper-surface recesses 38) upper-surface covering portions 46, having a shape that corresponds to the upper-surface recesses 38, side-surface covering portions 47 having a shape that corresponds to the side recesses 39, and underside covering portions 48 having a shape that corresponds to the underside recesses 40. In addition, cutouts 49 having a number and shape corresponding to the engaging projections 41 are formed in the upper edge of the side-surface covering portion 47. Furthermore, although not shown in the drawings, a pair of left and right carrier sections corresponding to the carrier sections 18A and 18B, and a plurality of cut off bridges (sections which connect the carrier sections and the portions of the thermal radiator member 45 shown in the drawings) corresponding to the cutoff bridges 28 are integrally provided on the thermal radiator member 45. The thermal radiator member 45 is connected, from the left side, to the integrated component consisting of the conductor plate 17, the front connector terminal contacts 30, the rear connector terminal contacts 33 and the first surface-insulation portion 37 (see FIGS. 15 and 16) by the upper-surface covering portions 46 being placed into the corresponding upper-surface recesses 38, the side-surface covering portion 47 being placed into the side recesses 39 while the engaging projections 41 are engaged into the cutouts 49, respectively, and the underside covering portions 48 being placed into the underside recesses 40 (see FIGS. 17 through 19).

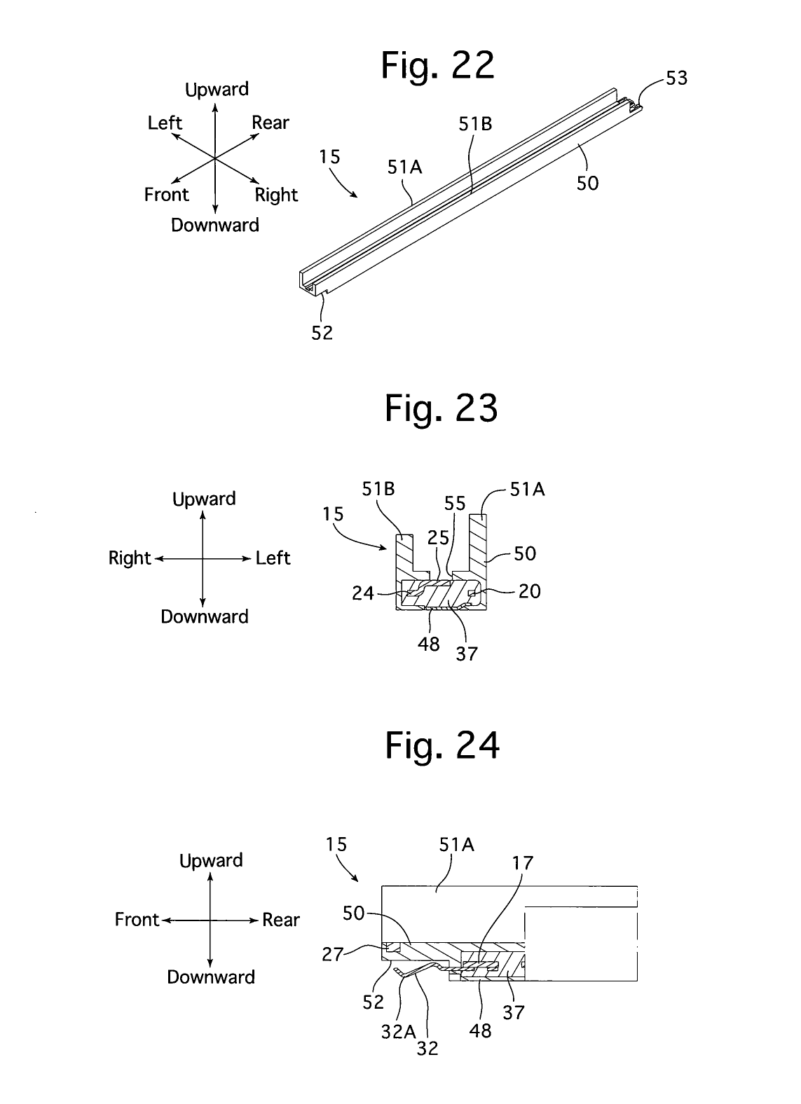

Subsequently, the integrated component consisting of the conductor plate 17, the front connector terminal contacts 30, the rear connector terminal contacts 33, the first surface-insulation portion 37 and the thermal radiator member 45 is conveyed in a rearward direction until reaching a predetermined position. Thereafter, a pair of secondary molding dies (not shown) made of metal are positioned above and below the integrated component (the conductor plate 17, the front connector terminal contacts 30, the rear connector terminal contacts 33, the first surface-insulation portion 37 and the thermal radiator member 45) and are closed over the integrated component so as to be accommodated inside the pair of secondary molding dies. Thereupon, a large number of support pins (not shown) that are provided in secondary molding dies are fitted into the respective conveyor holes (not shown) formed in the carrier sections of the thermal radiator member 45, to thereby fix the integrated component inside the secondary molding dies. Thereafter, injection molding (secondary molding) using a highly insulative resin material (e.g., a liquid crystal polymer, etc.) is carried out in the secondary molding dies. Subsequently, upon the resin material curing, each die of the secondary molding dies is separated, upwardly and downwardly, from the integrated component to thereby remove the integrated component (the conductor plate 17, the front connector terminal contacts 30, the rear connector terminal contacts 33, the first surface-insulation portion 37 and the thermal radiator member 45) from the secondary molding dies, thereby producing an integrated component in which the second surface-insulation portion 50 is integrally formed on the conductor plate 17, the anode terminal projections 23, the cathode terminal projection 27, the first surface-insulation portion 37 and the thermal radiator member 45 (see FIGS. 20 through 26). However, since an upper-surface exposing groove 55 is formed in the center, with respect to the width thereof, of the upper side of the second surface-insulation portion 50 along the longitudinal direction thereof, the upper surface of the above-described integrated component in the center, with respect to the width thereof, is exposed entirely ((part of) the anode terminal contacts 21, (part of) the cathode terminal contacts 25, (part of) the upper-surface covering portions 46, (part of) the anode terminal projections 23, and (part of) the cathode terminal projections 27) along the longitudinal direction thereof. Furthermore, the second surface-insulation portion 50 exposes (part of) the contact parts 32, (part of) the contact part 35, (part of) the underside covering portions 48, and the carrier sections and cutoff bridges of the thermal radiator member 45.

As shown in the drawings, the second surface-insulation portion 50 is integrally provided with an upwardly projecting clasping member 51A along the entire left edge portion on the upper surface of the second surface-insulation portion 50, and the second surface-insulation portion 50 is integrally provided with an upwardly projecting clasping member 51B, which has a lower height than that of the clasping member 51A, along the entire right edge portion on the upper surface of the second surface-insulation portion 50. A connection recess 52 is formed at the front end on the underside of the second surface-insulation portion 50, and the left and right front connector terminal contacts 30 (contact parts 32) are positioned in the connection recess 52. A connection projection 53 is provided at the rear lower end of the second surface-insulation portion 50 so as to project rearwardly therefrom, and the left and right rear connector terminal contacts 33 (contact parts 35) are exposed on the upper side of the connection projection 53. An underside exposing hole 54 which exposes the central portion, with respect to the width thereof, along the entirety of the underside covering portions 48 (excluding the left and right side portions thereof) is formed in the underside of the second surface-insulation portion 50. Furthermore, the second surface-insulation portion 50 covers the edge surfaces of the cutoff bridges 28 that were cut off at the primary cutting operation and exposed on the side surfaces of the first surface-insulation portion 37 (see FIGS. 11, 15 and 17).

Upon the secondary molding being completed, a secondary cutting operation is carried out in which the above-mentioned bridges of the thermal radiator member 45 are cut along straight lines along the left and right side surfaces of the second surface-insulation portion 50 in the forward/rearward direction by a secondary cutting device (not shown). Subsequently, a completed LED mounting module 15 having the shape shown in FIGS. 20 through 26 is achieved.

Thereafter, as shown in FIGS. 27 through 29, the LED elements 57 (three in the drawings, however, a much larger number of pairs are provided in practice), each having a light-emitting surface on upper surface thereof, are placed onto corresponding pairs (three pairs in the drawings, however, a much larger number of pairs are provided in practice) of anode and cathode terminal contacts 21 and 25 of the completed LED mounting module 15, and each of the LED elements 57 are attached to the corresponding pair of anode and cathode terminal contacts 21 and 25 by an adhesive or by using a heat transfer sheet. Furthermore, as shown in FIG. 29, anodes 58 of the LED elements 57 are connected to the corresponding anode terminal contacts 21 and cathodes 59 of the LED elements 57 are connected to the corresponding cathode terminal contacts 25 by the plurality of wire bondings 61 formed from a conductive metal material (e.g., gold or aluminum).

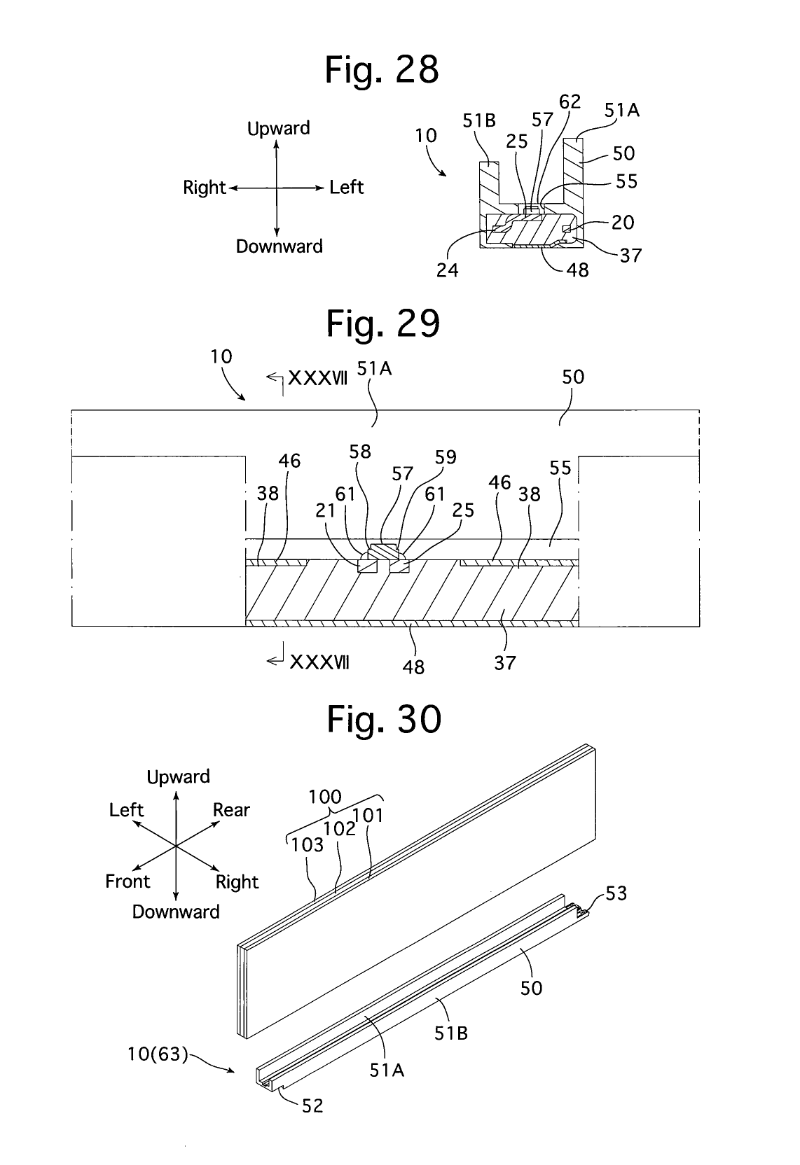

Subsequently, the upper edge portion (upper edge opening) of the upper-surface exposing groove 55 of the second surface-insulation portion 50 are covered with the sealant 62 (see FIG. 28) formed of a thermoset resin or an ultraviolet curable resin, etc., having transparent and insulative properties. Accordingly, the surfaces of the anode terminal contacts 21, the cathode terminal contacts 25, the LED elements 57 and the wire bondings 61 are covered by the sealant 62.

Front connector terminal contacts 30 (contact parts 32) and rear connector terminal contacts 33 (contact parts 35) of a LED module 10 are connectable with front connector terminal contacts 30 (contact parts 32) and rear connector terminal contacts 33 (contact parts 35) of another (adjacent) LED module 10. Namely, as shown in FIG. 26, when a connection projection 53 of one LED module 10 (positioned in front) is fitted into a connection recess 52 of the other (adjacent) LED module 10 (positioned behind) when the rear end edge of the one LED module 10 is brought into contact with the front end edge of the other LED module 10, the contact parts 35 of the left and right rear connector terminal contacts 33 of the one LED module 10 respectively come in contact with the undersides of the left and right contact protrusions 32A of the left and right contact parts 32 of the other LED module 10 while respectively elastically deforming the contact parts 32 in an upward direction. Therefore, since the upper surfaces of the rear connector terminal contacts 33 (contact parts 35) are covered by the connection recesses 52, and since the undersurfaces and side surfaces of the front connector terminal contacts 30 (contact parts 32) are covered by the connection projection 53, the surrounding area of the front connector terminal contacts 30 (contact parts 32) and the rear connector terminal contacts 33 (contact parts 35) are completely covered by the connection recess 52 and the connection projection 53. Note that a lock device (not shown) can be provided to hold connections between adjacent LED modules 10 when each of the front and rear ends of each LED module 10 is connected to an end portion of another adjacent LED module 10.

Accordingly, a connection recess 52 of yet another LED module 10 that is positioned behind the other LED module 10 can be connected to the connection projection 53 of the other LED module 10 (that is positioned behind the above-mentioned one LED module 10). In other words, it is possible to linearly connect a plurality of LED modules 10 to thereby configure an elongated light fixture 63 that is elongated in the forward/rearward direction.

Note that, as shown in FIG. 26, it is also possible to place a LED element 57 at the connecting edges of adjacent LED modules 10. Namely, since the cathode terminal projection 27 is exposed at the upper front-end portion of each LED module 10, and the anode terminal projection 23 is exposed at the upper rear-end portion of each LED module 10, when adjacent LED modules 10 are connected to each other, the cathode terminal projection 27 and the anode terminal projection 23 become adjacent to each other while having a space (distance) therebetween that is the same as the space (distance) between each pair of anode and cathode terminal contacts 21 and 25. Accordingly, it is possible to place and connect a LED element 57 onto adjacent cathode and anode terminal projections 27 and 23 in the same manner as in the case of placing and connecting a LED element 57 onto a pair of anode and cathode terminal contacts 21 and 25. Hence, if the LED elements 57 are connected to the corresponding cathode terminal projections 27 and the corresponding anode terminal projections 23 in such a manner, the LED elements 57 can be installed at equal intervals (distances) even in the case where a plurality of LED modules 10 are connected to each other, and moreover, the interval (distance) between adjacent LED elements 57 can be reduced (narrowed). Note that after a LED element 57 is connected to a cathode terminal projection 27 and an anode terminal projection 23, a sealant 62 is applied to the second surface-insulation portion 50.

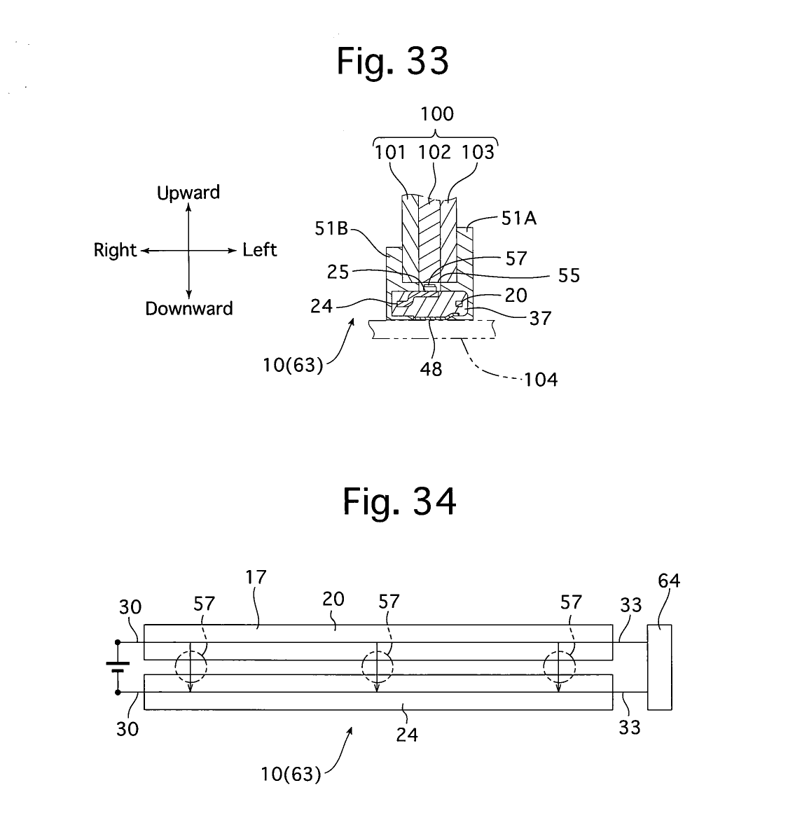

If one side edge of the LCD panel unit 100 (which is a laminate of the LCD panel 101, the light guide plate 102 and a reflection plate 103), having a rectangular shape as viewed in a front elevation, is fitted into a groove formed between the clasping member 51A and the clasping member 51B of the elongated light fixture 63 that has been assembled as described above, with the elongating direction of the light fixture 63 orientated vertically, so that the side edge surface of the LCD panel unit 100 contacts the upper surface of the second surface-insulation portion 50 (the base surface of the groove formed in between the clasping member 51A and the clasping member 51B) (see FIG. 33), the elongated light fixture 63 (each LED module 10) can be connected to the side edge of the LCD panel unit 100 with each LED element 57 facing a side end surface of the light guide plate 102. Furthermore, a thermal radiator plate 104 (shown in FIG. 33 as phantom lines) of a display device (e.g., an LCD television), into with the LCD panel unit 100 is in-built, can be brought into contact with the underside covering portions 48 of the thermal radiator member 45 of the elongated light fixture 63 (each LED module 10). If the elongated light fixture 63 and the LCD panel unit 100 are fixed to the thermal radiator plate 104 by bolts, etc., (not shown), the elongated light fixture 63, the LCD panel unit 100 and the thermal radiator plate 104 can be firmly integrated with each other.

As shown in the schematic diagram of FIG. 34, an anode terminal of a power source is connected to a left front connector terminal contact 30 (contact part 32) of a frontmost LED module 10, a cathode terminal of the power source is connected to a right front connector terminal contact 30 (contact part 32) of the frontmost LED module 10, and a short-circuit connector 64 is connected to the rear connector terminal contacts 33 of the rearmost LED module 10. Accordingly, when a main switch (not shown) of the LCD panel unit 100 is turned ON, since a series circuit is formed on the front connector terminal contacts 30 and the conductor plate 17 (current flows to each LED element 57), each LED element 57 emits light. The illumination light which each LED element 57 emits is reflected by the surface of the first surface-insulation portion 37 and the surface of the upper-surface covering portions 46 so that the illumination light proliferates along the light guide plate 102 and is further reflected by the reflector plate 103 to be reflected toward the LCD panel 101, so that the LCD panel 101 performs a displaying operation.

Furthermore, since the circuit formed on the conductor plate 17 and the front connector terminal contacts 30 constitute a series circuit, even if one LED element 57 were to become damaged (by breaking or burning out), the other remaining LED elements 57 would continue emitting light, and therefore, the LED module 10 is suitable for use in a device (such as, e.g., the LCD panel unit 100) in which a long life span and reliability are demanded. Furthermore, since the short-circuit connector 64 is also attached to the rearmost LED module 10, exposure of the rear connector terminal contacts 33 of the frontmost LED module 10 can be prevented. Accordingly, foreign matter can be prevented from adhering to the rear connector terminal contacts 33, and the rear connector terminal contacts 33 can be prevented from contacting other surrounding members, thereby preventing breakage thereof.

In the above-described LED module 10 of the illustrated embodiment, since the thermal radiator member 45, having superior thermal conductivity and rigidity, is configured so as to be positioned close to the LED elements 57 and also to expose the external surface of the LED mounting module 15, heat generated by each LED element 57 efficiently radiates externally from the LED mounting module 15 via the thermal radiator member 45. Furthermore, since it is possible (i.e., short-circuiting does not occur) to position the thermal radiator plate 104 (or an inner surface, etc., of a metal body of a display device into with the LCD panel unit 100 is in-built) close to the LED mounting module 15 (LED module 10), by utilizing the thermal radiator plate 104, a more effective thermal radiation effect can be obtained that otherwise cannot be obtained by the LED mounting module 15 (LED modules 10) alone.

Furthermore, since the entire surface of the metal conductor plate 17 (excluding the anode terminal contacts 21 and the cathode terminal contacts 25), having superior thermal conductivity and rigidity, is covered by the first surface-insulation portion 37 (formed from resin) and the second surface-insulation portion 50 (formed from resin), heat generated by each LED element 57 is efficiently received by the conductor plate 17. Accordingly, the heat generated by each LED element 57 is efficiently radiated externally from the LED mounting module 15 (LED modules 10) through the conductor plate 17, the (thin) first surface-insulation portion 37 and the (thin) second surface-insulation portion 50.

In other words, a synergistic thermal radiation effect of direct thermal radiation via the thermal radiator member 45 and indirect thermal radiation via the conductor plate 17, the first surface-insulation portion 37 and the second surface-insulation portion 50 can be obtained. Therefore, heat does not easily get trapped inside the LED mounting module 15, so that deterioration of the light-emitting efficiency of the LED elements 57 can be suppressed.

Furthermore, since the entire surface of the conductor plate 17, excluding the anode terminal contacts 21 and the cathode terminal contacts 25, is covered by the first surface-insulation portion 37 and the second surface-insulation portion 50, and also since the thermal radiator member 45, in which the upper-surface covering portions 46 and the underside covering portions 48 are exposed, is separated from the conductor plate 17 (i.e., the conductor plate 17 is insulated by the first surface-insulation portion 37), even if the thermal radiator plate 104 is made to contact the underside covering portions 48, no short-circuiting occurs between the thermal radiator member 45 (underside covering portions 48) and the thermal radiator plate 104.

In addition, since the side edge of the LCD panel unit 100 can be fitted in between the pair of clasping members 51A and 51B formed on the second surface-insulation portion 50, the LED module 10 can be precisely positioned and easily attached to the side edge of the LCD panel unit 100. Accordingly, since the light emitted from each LED element 57 can efficiently (without loss of light) be made incident onto the LCD panel unit 100, deterioration of luminance and luminance irregularities can be suppressed.

Furthermore, since the anodes 58 of the LED elements 57 and the anode terminal contacts 21 are connected to each other with wire bonding 61, and the cathodes 59 of the LED elements 57 and the cathode terminal contact 25 are connected to each other with wire bonding 61 (and also the anodes 58 and the anode terminal projections 23, and the cathodes 59 and the cathode terminal projections 27), it is unnecessary to carry out reflowing on the LED mounting module 15 at a high temperature, as in the case where soldering is used. Accordingly, warping or twisting of the LED mounting module 15 can be prevented, damage to the first surface-insulation portion 37, the second surface-insulation portion 50 and the LED elements 57 can be prevented, and deterioration of the reflectivity due to discoloring of the first surface-insulation portion 37 can be reduced. Furthermore, the distance between adjacent LED elements 57 can be narrowed (reduced). Accordingly, luminance irregularities of the LED modules 10 can be reduced, and the luminance thereof can be improved. Furthermore, in the case where the LED elements 57 are connected to the cathode terminal projections 27 and the anode terminal projections 23 by soldering, the productivity of the LED module 10 becomes extremely low; however, in the present invention, since wire bonding 61 is utilized, the LED elements 57 can be efficiently connected to the cathode terminal projections 27 and to the anode terminal projections 23.

In addition, since the anode terminal contacts 21, the cathode terminal contacts 25, the LED elements 57 and the surface of the wire bonding 61 are covered by the sealant 62 which is formed from an insulative material, the LED elements 57 and the wire bonding 61 can be protected thereby, and the risk of the anode terminal contacts 21 and the cathode terminal contacts 25 short-circuiting with other conductive members that are provided around the LED module 10 can be eliminated.

The present invention is not limited to above-described embodiment; the present invention can be applied while making various changes to above-described embodiment.

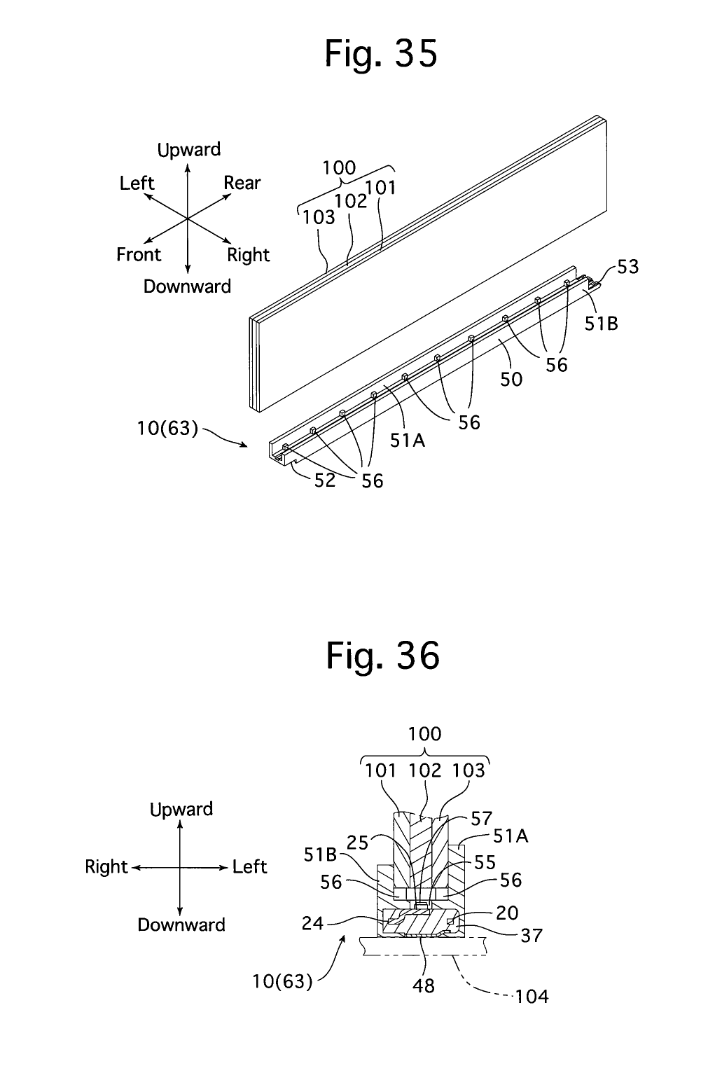

For example, as shown in FIGS. 35 and 36, a plurality of contact projections (contact protrusions) 56 can be provided so as to be arranged in the forward/rearward direction and integrally formed on the base of the aforementioned groove that is formed between the clasping member 51A and the clasping member 51B of the second surface-insulation portion 50 (the contact projections 56 constitute part of the second surface-insulation portion 50). As shown in the drawings, the left contact projections 56 are integrally formed with the clasping member 51A and the right contact projections 56 are integrally formed with the clasping member 51B so that the upper-surface exposing groove 55 is positioned between the left and right the contact projections 56. The upper surface of each contact projection 56 is a flat surface lying on a plane that is orthogonal to the vertical direction. Accordingly, when the side edge portion of the LCD panel unit 100 is fitted into the groove between the clasping member 51A and the clasping member 51B, the side edge surface of the LCD panel unit 100 comes into surface contact with the upper surfaces of the contact projections 56. As shown in FIG. 36, since a space (gap) is formed between the side edge surface of the LCD panel unit 100 and each LED element 57, heat generated by the LED elements 57 can be more efficiently radiated. Accordingly, the risk of the (side edge portion of) LCD panel unit 100 being adversely affected by heat form the LED elements 57 can be further reduced.

Note that instead of the plurality of contact projections 56 being arranged in the forward/rearward direction at predetermined intervals, a linear protrusion (contact protrusion; not shown) extending in the forward/rearward direction can be integrally formed on each (left and right) side of the base of the groove that is formed between the clasping member 51A and the clasping member 51B (the upper surface of each linear protrusion is a flat surface lying on a plane that is orthogonal to the vertical direction).

Furthermore, the contact projections 56 or the above-described linear protrusions can be formed separately from the second surface-insulation portion 50 and can be, thereafter, fixed to the second surface-insulation portion 50.

Furthermore, the conductor plate 17 can be formed from a metal material, having superior electrical conductively, thermal conductivity and rigidity, other than that described above.

The number of pairs of the anode and cathode terminal contacts 21 and 25 that are formed on one conductor plate 17 is not limited to the number in the illustrated embodiment; one or a plurality of pairs (other than the number in the illustrated embodiment) of the anode terminal contacts 21 and the cathode terminal contacts 25 are acceptable.

The surface of the conductor plate 17 can be alternatively plated with a plating other than silver, e.g., gold or tin plating is also suitable.

Furthermore, the LED module 10 (LED mounting module 15) can be produced in a different manner (sequence) to that described above. For example, the front connector terminal contacts 30 and/or the rear connector terminal contacts 33 can be integrally formed with the conductor plate 17; or the thermal radiator member 45 can be attached and/or the second surface-insulation portion 50 formed without cutting off the carrier-connector sections 19 and the cutoff bridges 28 of the conductor plate 17, and thereafter, the carrier-connector sections 19 and the cutoff bridges 28 can be cut off. Furthermore, a portion corresponding to both the first surface-insulation portion 37 and the second surface-insulation portion 50 can be integrally provided as an integral surface-insulation portion using one type of resin material by insert-molding the conductor plate 17, the front connector terminal contacts 30, the rear connector terminal contacts 33 and the thermal radiator member 45 inside the molding die (the resin molding process can be carried out in a single operation).

Furthermore, the second surface-insulation portion 50 can be formed so that the side-surface covering portion 47 of the thermal radiator member 45 is exposed, and so that a thermal radiator plate contacts the surface of the side-surface covering portion 47. Furthermore, the thermal radiator member 45 can be divided into a plurality of thermal radiator members, and these thermal radiator members can be individually attached to the LED module 10.

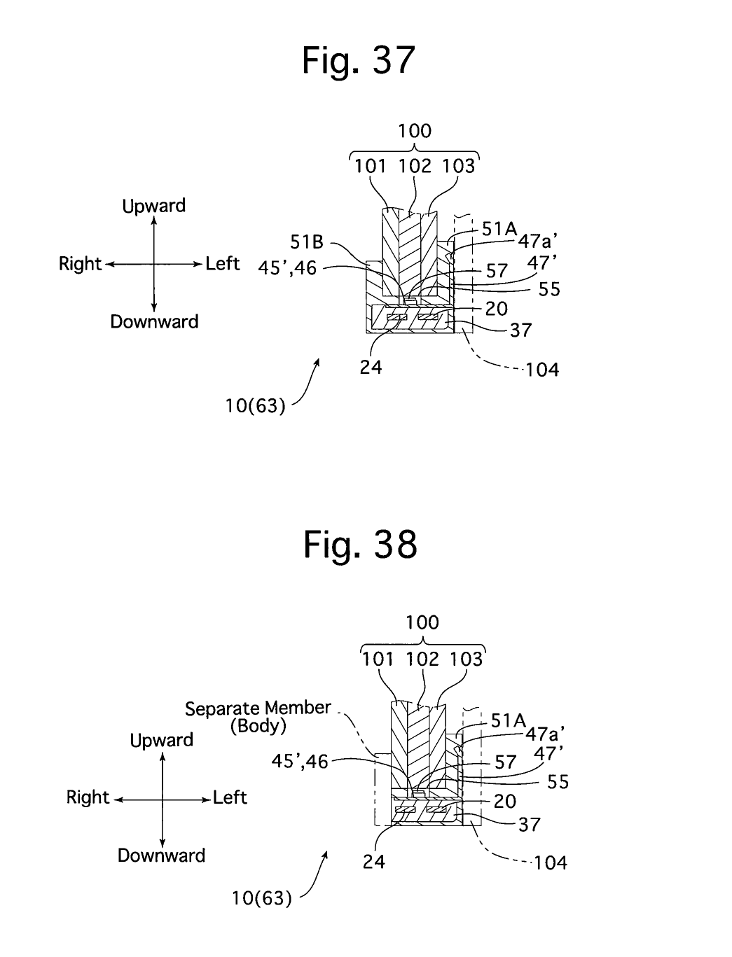

Furthermore, as shown in FIG. 37 (FIG. 37 is an enlarged sectional view similar to that of FIG. 33, taken along a line that corresponds to the XXXVII-XXXVII line of FIG. 29), a thermal radiator member 45′ can be configured in a shape that includes the upper-surface covering portions 46, a single side-surface covering portion 47′ extending upwardly from the left side edge of each upper-surface covering portions 46, and a retaining portion 47a′ extending upwardly in a diagonal rightward direction from an upper edge of each side-surface covering portion 47′. In this case, the side-surface covering portions 47′ can be exposed at a side surface of the second surface-insulation portion 50 (or an integral surface-insulation portion corresponding to a combination of both the first surface-insulation portion 37 and the second surface-insulation portion 50), the thermal radiator plate 104 can be orientated at an angle 90 degrees different from that of the illustrated embodiment and made to contact the side-surface covering portions 47′, and the elongated light fixture 63 and the LCD panel unit 100 can be fixed to the thermal radiator plate 104 by bolts, etc. (not shown). Even in such an arrangement, a thermal radiation effect can be achieved using the thermal radiator plate 104, and furthermore, a superior thermal radiation effect can be achieved by increasing the vertical length of the side-surface covering portions 47′. Furthermore, since each side-surface covering portion 47′ is provided with the retaining portion 47a′, which is embedded into the second surface-insulation portion 50 (or the above-described integral surface-insulation portion), the thermal radiator member 45 can be effectively prevented from coming off (falling off) the second surface-insulation portion 50 (or the above-mentioned integral surface-insulation portion).

Furthermore, as shown in FIG. 38, either the clasping member 51A or the clasping member 51B (the 51B in FIG. 38) and a portion position directly below can be omitted from the first surface-insulation portion 37 and the second surface-insulation portion 50 (or an integral surface-insulation portion), and one side edge portion of the LCD panel unit 100 (the side edge portion opposite to the 51A) can be fitted into a groove formed between a separate member other than the thermal radiator plate 104 (e.g., a side wall of a body that houses the elongated light fixture 63 and the LCD panel unit 100, as indicated in FIG. 38) and the clasping member 51A. In this modified embodiment, it is also possible to precisely position and easily attach the LED module 10 to the side edge portion of the LCD panel unit 100. Note that the integral member consisting of the elongated light fixture 63 and the LCD panel unit 100 can be obtained by, for example, fixing the thermal radiator plate 104 to the elongated light fixture 63 using bolts, etc., with the thermal radiator plate 104 and the elongated light fixture 63 mutually contacting each other, and thereafter, fixing the LCD panel unit 100 that is interposed between the elongated light fixture 63 (the clasping member 51A) and the above-mentioned separate member to the elongated light fixture 63 (the clasping member 51A) and the above-mentioned separate member using bolts, etc.

Furthermore, soldering can be used instead of the wire bonding 61.

In addition, a component other than the LCD panel unit 100 can be fitted in between the clasping member 51A and the clasping member 51B of the LED module 10, or between one of the clasping member 51A and the clasping member 51B of the LED module 10 and the above-mentioned separate member. For example, if a transparent plastic bar member equipped with a dispersion lens is fitted in between the clasping member 51A and the clasping member 51B of the LED module 10, an illumination component can be configured from the LED module 10 and this transparent plastic bar.

Other obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A semiconductor light-emitting element mounting module, comprising:
a metal conductor plate including an anode terminal contact and a cathode terminal contact formed on one side thereof, wherein an anode and a cathode of a semiconductor light-emitting element is connectable to said anode terminal contact and said cathode terminal contact, respectively;
a metal thermal radiator member which is provided separate from said metal conductor plate; and
a surface-insulation portion which covers the surfaces of said metal conductor plate and said thermal radiator member while exposing at least a part of said thermal radiator member, exposing said anode terminal contact and said cathode terminal contact,
wherein a clasping member is provided on a part of said surface-insulation portion which covers said one side of said metal conductor plate, said clasping member projecting from said part of said surface-insulation portion and in an opposite direction with respect to said one side of said metal conductor plate, and wherein said clasping member can come into contact with a light-receiving member, which receives light that is emitted from said semiconductor light-emitting element.

2. The semiconductor light-emitting element mounting module according to claim 1, wherein a pair of said clasping members, into which said light-receiving member can be positioned therebetween, are provided on said part of said surface-insulation portion which covers said one side of said metal conductor plate, wherein said pair of clasping members interposes said anode terminal contact and said cathode terminal contact so that said pair of clasping members face each other.

3. The semiconductor light-emitting element mounting module according to claim 2, wherein a contact protrusion, to which an end surface of said light-receiving member is contactable, is formed on said part of said surface-insulation portion which covers said one side of said metal conductor plate, wherein said contact protrusion is positioned between said pair of clasping members and projects from said part of said surface-insulation portion and in said opposite direction with respect to said one side of said metal conductor plate by a projecting amount smaller than that of said pair of clasping members.

4. The semiconductor light-emitting element mounting module according to claim 1, wherein said surface-insulation portion exposes part of said thermal radiator member at said one side and exposes a part that is different from said part of said thermal radiator member on a side that is different from said one side.

5. The semiconductor light-emitting element mounting module according to claim 1, further comprising:
a pair of connector terminal contacts which are electrically conductive with said anode terminal contact and said cathode terminal contact, respectively,
wherein said surface-insulation portion exposes said pair of connector terminal contacts, and
wherein said pair of connector terminal contacts are connectable to the pair of connector terminal contacts of another said semiconductor light-emitting element mounting module.

6. The semiconductor light-emitting element mounting module according to claim 5, wherein said metal conductor plate and said connector terminal contacts are separate members.

7. The semiconductor light-emitting element mounting module according to claim 5, wherein said metal conductor plate comprises a linearly extending member, and
wherein one said pair of connector terminal contacts is provided at each end of said metal conductor plate, with respect to the elongated direction of said metal conductor plate.

8. The semiconductor light-emitting element mounting module according to claim 1, wherein said anode terminal contact and said cathode terminal contact constitute a pair of terminal contacts, and wherein said metal conductor plate comprises a plurality of said pairs of terminal contacts.

9. A semiconductor light-emitting element module comprising:
said semiconductor light-emitting element mounting module according to claim 8;
a plurality of said semiconductor light-emitting elements, wherein an anode and a cathode of each of said semiconductor light-emitting elements are respectively connected to said anode terminal contact and said cathode terminal contact of each corresponding said pair of terminal contacts, and
wire bonding which is applied onto said anode of each said semiconductor light-emitting element and each said anode terminal contact, and onto said cathode of each said semiconductor light-emitting element and each said cathode terminal contact.

10. The semiconductor light-emitting element module according to claim 9, further comprising a transparent resin sealant which covers the surfaces of said semiconductor light-emitting elements and said wire bonding.
